(19) United States
(12) Patent Application Publication
(10) Pub. No.: US 2013/0038684 A1
(43) Pub. Date: Feb. 14, 2013

(54) SYSTEM, METHOD, AND COMPUTER PROGRAM PRODUCT FOR RECEIVING STEREOSCOPIC DISPLAY CONTENT AT ONE FREQUENCY AND OUTPUTTING THE STEREOSCOPIC DISPLAY CONTENT AT ANOTHER FREQUENCY

(71) Applicant: Gerrit Slavenburg, Fremont, CA (US)

(72) Inventor: Gerrit Slavenburg, Fremont, CA (US)

(73) Assignee: NVIDIA CORPORATION, Santa Clara, CA (US)

(21) Appl. No.: 13/208,290

(22) Filed: Aug. 11, 2011

(51) Int. Cl. H04N 13/00

(52) U.S. Cl. 348/43; 348/E13.068

(57) ABSTRACT

A system, method, and computer program product are provided for receiving stereoscopic display content at one frequency and outputting the stereoscopic display content at another frequency. In use, a frame of stereoscopic display content intended for viewing by a first eye of a user is received at a first frequency. Additionally, the stereoscopic display content is output at a second frequency by outputting a first instance of the frame without illumination by a backlight, and sequentially outputting one or more additional instances of the frame with illumination by the backlight.

### FIELD OF THE INVENTION

The present invention relates to video displays, and more particularly to displaying stereo content utilizing video displays.

### BACKGROUND

Various display devices are equipped for both mono and stereo viewing. Unlike mono viewing, stereo viewing involves the display of separate content for the right and left human eye. Specifically, such stereo viewing requires the presentation of a left image to the left human eye and a right image to the right human eye. In one particular type of stereo viewing, namely time sequential stereo viewing, such left and right images are presented in an alternating manner.

Numerous technologies are capable of providing such stereo viewing. For example, dual projectors provide stereo viewing with polarized light and polarized glasses. Further, time sequential displays [e.g. cathode ray tube (CRT) displays, digital light processing (DLP) projectors, liquid crystal displays (LCDs), etc.] provide stereo viewing when combined with active shutter glasses that open corresponding left and right shutters at the appropriate time. Lenticular displays constitute yet another example of displays with stereo viewing capabilities. Lenticular displays radiate different views into viewing “cones” so that each eye (in a different cone) is subjected to a different image.

In each of such stereo viewing technologies, crosstalk (e.g. leakage, etc.) typically occurs. Crosstalk refers to the situation where left eye display content is displayed to a right eye of a user and right eye display content is displayed to a left eye of the user. Such crosstalk is particularly visible when a bright white object occurs on a dark background, and when parallax between a left and right image of the object is large. In such cases, a perception of a “ghost” of the object results, hence the perceived effect is often called “ghosting.” Ghosting reduces the quality of a stereo viewing experience.

In the context of the aforementioned dual projectors with polarized light, crosstalk may occur due to a limited rejection of an unwanted image by associated polarized glasses. Further, in the case of time sequential displays with shutter glasses, crosstalk may occur due to both display persistence and limited image rejection by a “dark” state of associated shutters. It may also occur due to shutter glasses opening/closing time inaccuracies, etc. In the case of lenticular displays, optical properties of such display technology may cause crosstalk between adjacent viewing cones.

Prior art FIG. 1 illustrates a display system 100 that exhibits crosstalk, in accordance with the prior art. As shown, L(i, j, n) corresponds with an image frame sent to the display system 100 to be presented to a left eye at time=n, consisting of a 2-dimensional array of pixels. Specifically, L(i, j, n) is the value of the pixel at x-coordinate=i, at y-coordinate=j, and at time t=n. Similarly, R(i, j, n) corresponds to an image frame sent to the display system 100 to be presented to a right eye.

In use, however, the actual light reaching each eye contains the appropriate image in addition to some error components due to crosstalk. The term d*R(i, j, n), for example, represents crosstalk from a current right frame into the left eye, such as might occur in the aforementioned dual projection/polarized systems, etc. In the context of time-sequential stereo viewing, it is possible that there may even be crosstalk originating from a previous image. For example, if it is assumed that the time sequence order is L(n−1), R(n−1), L(n), R(n), etc., it is possible for a remnant of a R(n−1) image to reach the left eye at time=n. This is represented by the term e*R(i, j, n−1). Still yet, the term f*L(i, j, n) represents a crosstalk from a current left frame into the right eye.

As mentioned earlier, the ghosting that results from the foregoing crosstalk serves to reduce the quality of a stereo viewing experience. One technique which has been used to overcome the unwanted ghosting effect of crosstalk and which has also been used to increase the frequency at which stereo content is output is shown in Prior art FIG. 2. As shown, this technique has involved operating with the backlight of the display device in a constant activated state, and drawing an all black image frame between the left and right image frames. Shutter glasses are worn by a user, and operate such that the left/right lenses of he glasses are each capable of being in an open orientation and a dosed orientation. Only the left lens is open during the display of the left image and the black image proceeding the left image, such that only a left eye of the user receives the left image and the black image proceeding the left image. Similarly, only the right lens is open during the display of the right image and the black image proceeding the right image, such that only a right eye of the user receives the right image and the black image proceeding the right image.

Thus, the aforementioned technique reduces the unwanted ghosting effect by preventing an eye of the user from viewing an image when that image is being overwritten by another image intended for viewing by the other eye of the user. Unfortunately, this technique reduces an amount of light that reaches the user's eyes by requiring the user to view the black images. There is thus a need for overcoming these and/or other problems associated with the prior art.

### SUMMARY

A system, method, and computer program product are provided for receiving stereoscopic display content at one frequency and outputting the stereoscopic display content at another frequency. In use, a frame of stereoscopic display content intended for viewing by a first eye of a user is received at a first frequency. Additionally, the stereoscopic display content is output at a second frequency by outputting a first instance of the frame without illumination by a backlight, and sequentially outputting one or more additional instances of the frame with illumination by the backlight.

### BRIEF DESCRIPTION OF THE DRAWINGS

Prior art FIG. 1 illustrates a display system that exhibits crosstalk, in accordance with the prior art.

Prior art FIG. 2 illustrates a system used to overcome the unwanted ghosting effect of crosstalk and to increase the frequency at which stereo content is output, in accordance with the prior art.

FIG. 3 illustrates a method for receiving stereoscopic display content at one frequency and outputting the stereoscopic display content at another frequency, in accordance with one embodiment.

FIG. 4 illustrates a system for duplicating stereoscopic display content received at one frequency for changing the frequency at which stereo content is output, in accordance with another embodiment.

FIG. 5 illustrates a display system for duplicating stereoscopic display content received at one frequency for changing the frequency at which stereo content is output, in accordance with yet another embodiment.

FIG. 6 illustrates an exemplary computer system in which the various architecture and/or functionality of various embodiments may be implemented.

### DETAILED DESCRIPTION

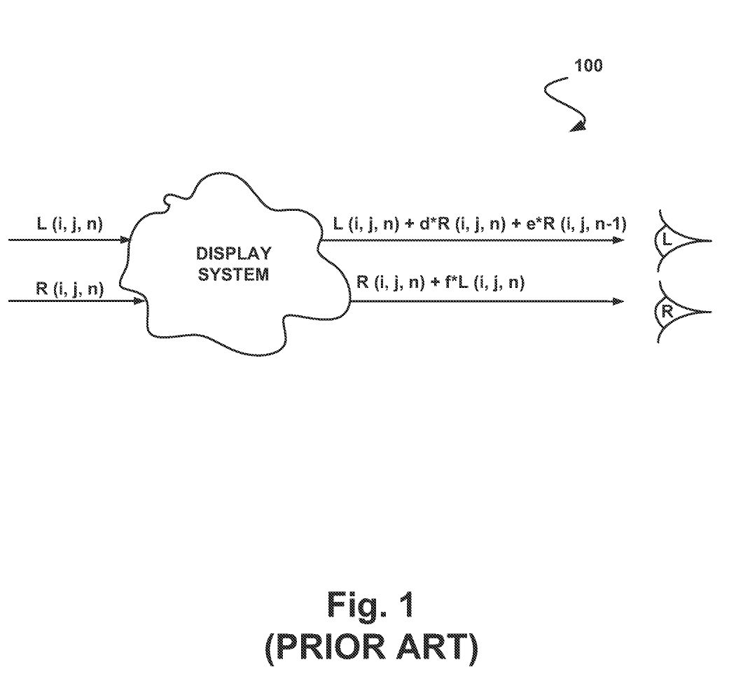

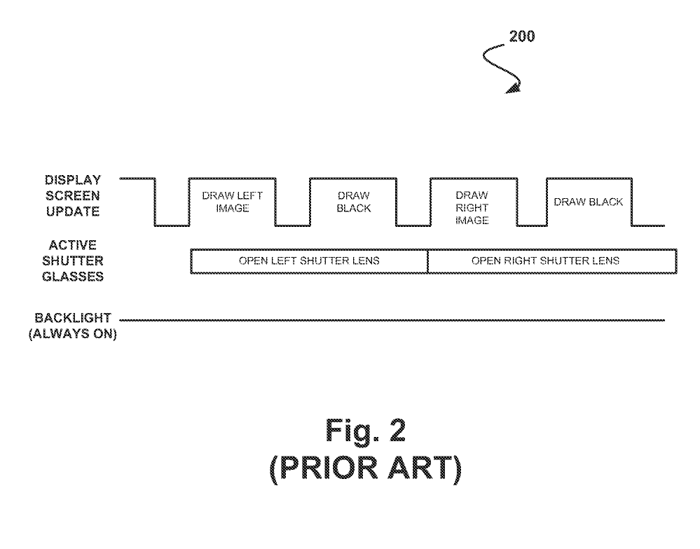

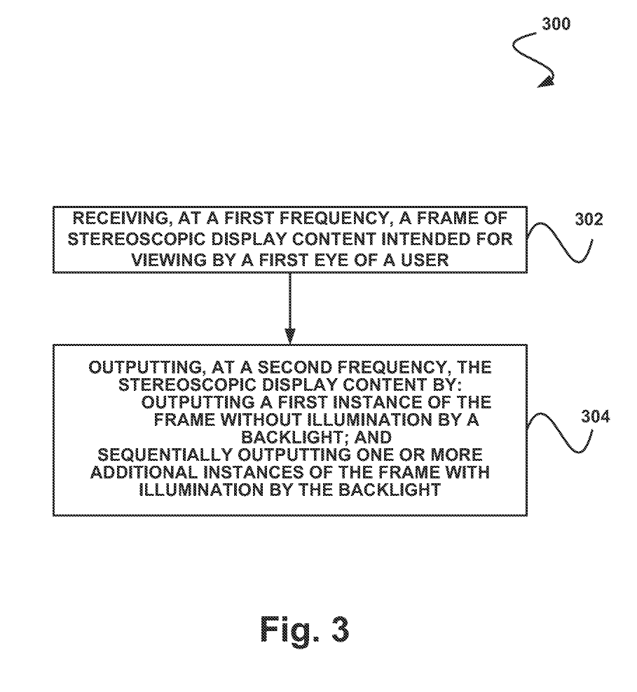

FIG. 3 shows a method 300 for receiving stereoscopic display content at one frequency and outputting the stereoscopic display content at another frequency, in accordance with one embodiment. As shown in operation 302, a frame of stereoscopic display content intended for viewing by a first eye of a user is received at a first frequency. In the context of the present description, the stereoscopic display content may include images, portions thereof (e.g. pixel information, etc.), and/or anything else capable of being processed for the purpose of being displayed stereoscopically (e.g. three-dimensionally) to a user.

For example, the stereoscopic display content may include display content intended for viewing by a left eye of the user and different display content intended for viewing by a right eye of the user. As noted above, the stereoscopic display content includes at least one frame. Thus, each frame may be intended for viewing by the left eye of the user or intended for viewing by the right eye of the user. For example, the frame may include at least one of first display content to be displayed to a first eye of the user and second display content to be displayed to a second eye of the user.

In one embodiment, the stereoscopic display content may include a plurality of frames which are received, where the frames that are received alternate between being intended for viewing by the left eye of the user and intended for viewing by the right eye of the user. For example, frame L1 may be a frame of the stereoscopic display content intended for viewing by the left eye of the user, frame R1 may be a frame of the stereoscopic display content intended for viewing by the right eye of the user, frame L2 may be a frame of the stereoscopic display content intended for viewing by the left eye of the user, and frame R2 may be a frame of the stereoscopic display content intended for viewing by the right eye of the user. In such example, the frames may be in a sequence of L1, R1, L2, R2, and so on and may be received over a digital visual interface (DVI), for example of a computer, at 120 Hertz]. Optionally, a vertical blanking interval (i.e., time period in which no frame is received) may exist between each aforementioned pair of sequentially received frames.

In another embodiment, the stereoscopic display content may include a plurality of frames which are received in a side-by-side format or a stacked frame format (i.e. over-under format). For example, with respect to the side-by-side format, a frame intended for viewing by a left eye of the user may be received in parallel with a frame intended for viewing by the right eye of the user. Each side-by-side/stacked pair of frames may be received over a high-definition multimedia interface (HDMI), for example of a television, at 24, 50 or 60 Hertz.

Additionally, as shown in operation 304, the stereoscopic display content is output at a second frequency. Specifically, the stereoscopic display content is output at the second frequency by outputting a first instance of the frame without illumination by a backlight, and sequentially outputting one or more additional instances of the frame with illumination by the backlight.

For example, the frame may be duplicated to form at least one additional (i.e. second) instance of a received first instance of the frame. Duplicating the at least one frame may include creating a copy, replica, etc. of the frame. Thus, each received frame of the stereoscopic display content may be duplicated, such that at least two instances of each frame of the stereoscopic display content exist. Of course, as another option, the frame may be stored in memory and output at least twice, once as the first instance of the frame and at least a second time as the additional instance of the frame.

In one embodiment, the frame received in operation 302 may be buffered. For example, the frame may be buffered during receipt of the frame. To this end, in one embodiment, as pixel information is received for each pixel of the frame of the stereoscopic display content, such pixel information may be buffered.

The frame may then optionally be duplicated to form the one or more additional instances of the frame from the buffered frame. In one embodiment, the frame may be duplicated by duplicating the pixel information as it is received, such that as pixel information for a pixel of a frame is received, that pixel information may be duplicated. Of course, any desired delay in the duplication may be introduced whereby, for example, a frame is duplicated after the entire frame is received, etc.

As noted above, the first instance of the frame and the additional instance(s) of the frame are output in sequence. Thus, the first instance of the frame may be output, and thereafter the additional instance(s) of the frame may be output, such that the one or more additional instances of the frame are output sequential to the output of the first instance of the frame. In one embodiment, the additional instance(s) of the frame may be output to replace an otherwise outputted black frame. As an option, only a vertical blanking interval may exist between the output of the first instance of the frame and the additional instance(s) of the frame, such that the one or more additional instances of the frame may be output sequential to a vertical blanking interval following the output of the first instance of the frame.

Just by way of example, where a plurality of frames are received at the first frequency including a first frame of first display content to be displayed to a first eye of a user and a second frame of second display content to be displayed to a second eye of the user, the outputting, at the second frequency, the stereoscopic display content may include (1) outputting in sequence the first instance of the first frame and the additional instance(s) of the second frame, and (2) after the sequential output of the first instance of the first frame and the additional instance(s) of the first frame, outputting in sequence a first instance of the second frame and additional instance(s) of the second frame. Thus, in the example described above where the frames of the stereoscopic display content are received as L1, R1, L2, R2, etc., the stereoscopic display content may be output at the second frequency as L1, L1, R1, R1, L2, L2, R2, R2, etc.

As noted above, the first instance of the frame is output without illumination by a backlight. Such backlight may include any light capable of being utilized for illuminating a display of the frame for viewing by the user, in the manner described herein. For example, the backlight may be deactivated during the outputting of the first instance of the frame. In this way, the first instance of the frame may be prevented from being illuminated, and thus incapable of being viewed by the user.

Furthermore the additional instance(s) of the frame are output with illumination by the backlight. For example, the backlight may be activated in response to the outputting of the additional instance(s) of the frame. As an option, the backlight may be activated a predetermined amount of time after initiation of the outputting of the additional instance(s) of the frame. Such backlight may then be held in the activated orientation during the outputting of the additional instance(s) of the frame, such that the additional instance(s) of the frame may be illuminated for allowing the user to view the same.

In one embodiment, the second frequency may be faster than the first frequency. For example, where the first frequency is 120 Hertz, as noted above, the second frequency may optionally include 240 Hertz. 1n such example, each frame of the stereoscopic display content may be received over a 1/120 of a second, but each of the first instance of the frame and an additional instance of the frame may be output at 1/240 of a second. This may allow stereoscopic display content received at 120 Hertz to be output at 240 Hertz, such that display devices operating at 240 Hertz may output stereoscopic display content received at 120 Hertz. It should be noted that the display device may include, but is not limited to a dual projector with polarized light and polarized glasses, a time sequential display [e.g. cathode ray tube (CRT) display, a digital light processing (DLP) projector, a liquid crystal display (LCD), a Plasma display, etc.].

As an option, the received frame or the output first instance of the frame and the output additional instance(s) of the frame may be further processed prior to being output. Just by way of example, a vertical compensation algorithm may be applied to the frame, for compensating for any inequality in the intensity of each line of the frame. One example of such vertical compensation that may be applied to the at least two duplicate frames is disclosed in U.S. patent application Ser. No. 12/901,447, filed Oct. 8, 2010, entitled “System, Method, And Computer Program Product For Utilizing Screen Position Of Display Content To Compensate For Crosstalk During The Display Of Stereo Content,” by Gerrit A. Slavenburg, which is hereby incorporated by reference in its entirety.

To this end, stereoscopic display content received at a first frequency may be output at a second different (e.g. faster) frequency, namely by duplicating an output of a received frame, as described above. In one embodiment, the method 300 may be implemented by a television. For example, the frame(s) may be received and output by a processor of the television utilized for the outputting of the stereoscopic display content. In another embodiment, the method 300 may be implemented by a computer. For example, the frame(s) may be received by a processor of a computer connected to a display utilized for the outputting of the stereoscopic display content. Of course, however, the method 300 may be implemented by any desired device capable of being utilized to output stereoscopic display content for display (e.g. a monitor, laptop, etc.).

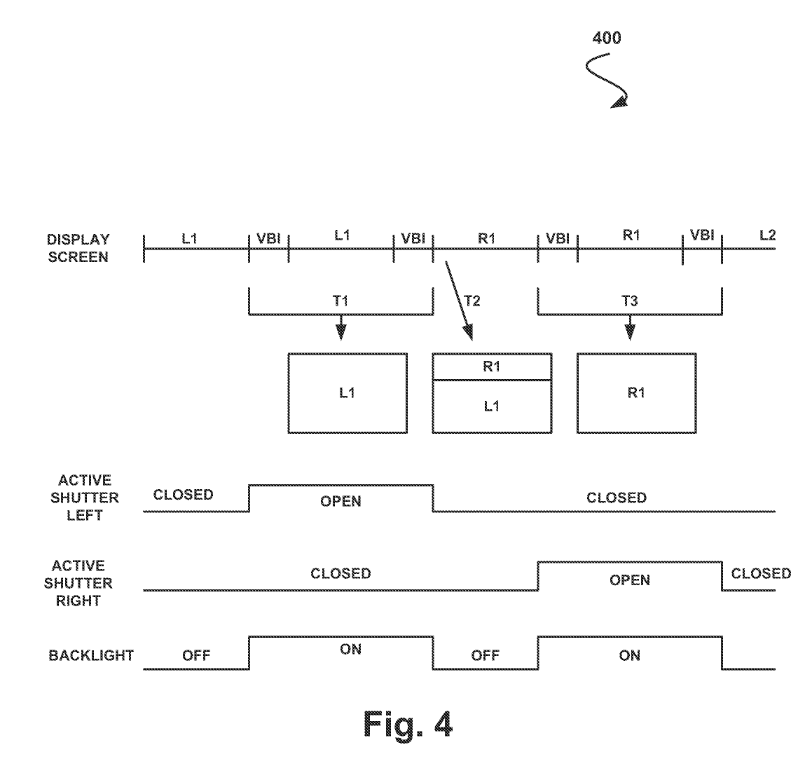

FIG. 4 illustrates a system 400 for duplicating stereoscopic display content received at one frequency for changing the frequency at which stereo content is output, in accordance with another embodiment. As an option, the system 400 may be implemented in the context of the method of FIG. 3. Of course, however, the system 400 may he implemented in any desired environment. Further, the definitions introduced hereinabove may apply during the following description.

As shown, a display screen [e.g. liquid crystal display (LCD) screen outputs duplicate frames of stereoscopic display content. The frames are output in the sequence of: a first instance of a first frame intended for viewing by a left eye of a user (L1), a second duplicate instance of the first frame (L1), a first instance of a second frame intended for viewing by a right eye of the user (R1), a second duplicate instance of the second frame (R1), a first instance of a third frame intended for viewing by a left eye of the user (L2), and so on. A vertical blanking interval (VBI) exists between each sequentially displayed pair of frames.

During time T1, which is the time from when the vertical blanking interval following the first instance of L1 starts to when the vertical blanking interval following the second instance L1 ends, the image displayed by the display screen only consists of the image of frame L1. Thus, crosstalk does not exist in the displayed image at time T1. Accordingly, during time T1, a left active shutter lens of active shutter glasses worn by the user is opened, to allow the left eye of the user to view frame L1. In addition, a right active shutter lens of the active shutter glasses is closed, to prevent the right eye of the user from viewing frame R1. It should be noted that examples of such active shutter glasses are disclosed in U.S. Pat. No. 7,724,211, filed Aug. 4, 2006. entitled “System, Method, And Computer Program Product For Controlling Stereo Glasses Shutters,” by Slavenburg et al.; and U.S. patent application Ser. No. 11/462,535, filed Aug. 4, 2006, entitled “System, Method, And Computer Program Product For Increasing An LCD Display Vertical Blanking Interval,” by Slavenburg et al., both of which are incorporated by reference in their entirety.

During time T2, which is a time during which the first instance of R1 is in the process of being displayed by the display screen (i.e. when any line other than the last line of R1 has been output on the display screen), the image displayed on the display screen consists of a combination of the portion of R1 that has been output to the display screen and the portion of L1 that has not yet been overwritten via the output of the portion of R1 to the display screen. Thus, at time T2 crosstalk exists in the R1 image being displayed (namely the remaining portion of L1 being displayed). Accordingly, during time T2 (i.e. or whenever there is crosstalk in the image being displayed), both the left active shutter lens and the right active shutter lens may be closed. However, as noted in more detail below, the backlight is controlled to prevent the user from viewing the image having crosstalk regardless of the opened/closed position of the shutter glasses.

During time T3, which is the time from when the vertical blanking interval following the first instance of R1 starts to when the vertical blanking interval following the second instance R1 ends, the image displayed by the display screen only consists of the image of frame R1. Thus, crosstalk does not exist in the displayed image at time T3. Accordingly, during time T3, the right active shutter lens of the active shutter glasses may be opened, to allow the right eye of the user to view frame R1. 1n addition, a left active shutter lens of the active shutter glasses may be closed, to prevent the left eye of the user from viewing frame R1.

To this end, as shown, at least two duplicate frames, which are first display content to be displayed to a first eye of a user, may include a first frame and a second frame displayed after the first frame. During the outputting of the first frame of the at least two duplicate frames, active shutter glasses utilized by the user to view the stereoscopic display content may be instructed to close a lens worn over the first eye of the user and to close a lens worn over a second eye of the user. However, during the outputting of the second frame of the at least two duplicate frames, the active shutter glasses may be instructed to open the lens worn over the first eye of the user and to close the lens worn over the second eye of the user.

As an option, the opening of each of the left and right active shutter lenses, as described above, may be delayed a predetermined amount. For example, the active shutter lenses may be opened slightly later to allow for the display screen to stabilize in the new state (e.g. where the delay is consistent with the display screen response time). Also, the active shutter lenses may be kept open slightly longer than shown, since the display screen may not necessarily immediately change state (i.e., as a result of the display screen response time).

As also shown, a backlight is controlled to operate in association with the output of the stereoscopic display content. The backlight includes any device emitting light to the display screen for illuminating an image displayed on the display screen for viewing by a user. The backlight is in an off state (i.e. a deactivated state), whereby light is not emitted from the backlight, during output of a first instance of a frame of the stereoscopic display content. By deactivating the backlight during such time, the display screen may be prevented from showing a user an image having crosstalk (i.e. an image in the process of being written over by another image), with respect to time T2.

The backlight is an on state (i.e. an activated state), whereby light is emitted from the backlight, during output of a second instance of a frame of the stereoscopic display content and during the VBI preceding and immediately following such second instance. By activating the backlight during such time, the display screen may show a user an image void of any crosstalk, with respect to time T1 and T3.

Thus, the at least two duplicate frames which are output by the display screen may include a first frame and a second frame displayed after the first frame. In such example, the backlight of a display device having the display screen for outputting the stereoscopic display content may be deactivated during the outputting of the first frame of the at least two duplicate frames. Further, the backlight may be activated in response to the outputting of the second frame of the at least two duplicate frames.

As an option, the backlight may be activated a predetermined amount of time after initiation of the outputting of the second frame of the at least two duplicate frames (or optionally a predetermined amount of time after initiation of a VBI preceding the outputting of the second frame), and may further be held for the predetermined amount of time after completion of the outputting of the second frame of the at least two duplicate frames. Such predetermined amount of time may be based on the responsiveness of the display device in outputting the stereoscopic display content in response to receipt of the same (e.g. from a buffer). 1n one embodiment where the display device is a television, the predetermined amount of time may be set by the television. 1n another embodiment where the display device is a monitor of a computer, the predetermined amount of time may be set by the graphics processing unit (GPU) of the computer.

By controlling the operation of the backlight in the manner described above, only images void of crosstalk may be shown to a user by the display device. This may allow for different types of active shutter glasses to be utilized by a user for viewing the stereoscopic display content. For example, the active shutter glasses worn by the user to view the stereoscopic display content may be three state active shutter glasses, as described as being used above (i.e. which are capable of alternating between a right lens open/left lens closed state, a left lens open/right lens closed state, and a right lens closed/left lens closed state), or optionally two state active shutter glasses (i.e. only capable of alternating between a right lens open/left lens closed state and a left lens open/right lens closed state).

In the embodiment shown, the active shutter glasses used in combination with the display screen and backlight are the three active state shutter glasses. As shown, the three state active shutter glasses remain in the right lens closed/left lens closed state while the backlight is off. When the backlight is on, the three state active shutter glasses are in a state where the lens of the eye intended to view the outputted frame is in an open state and the other lens (of the eye not intended to view the outputted frame) is in a closed state. Thus, the three state active shutter glasses may also optionally incorporate the delay applied to the activation/deactivation of the backlight described above as the predetermined amount of time.

As noted above, two state active shutter glasses may optionally be used in combination with the display screen and backlight. In such embodiment, when the backlight is on, the two state active shutter glasses may be in the same state as the state of the three state active shutter glasses described above while the backlight is on. However, the two state active shutter glasses may remain in any desired state when the backlight is off, since the deactivation of the backlight will prevent the user from viewing any image from the display screen.

Still yet, by controlling the operation of the backlight in the manner described above, a same brightness may be achieved as with the prior art technique shown in FIG. 2, but with half of the backlight energy being utilized by such prior art technique. As another option, a higher current may be applied to the backlight when in the activated state to double the brightness of the prior art technique shown in FIG. 2 while using at least approximately the same backlight energy being utilized by such prior art technique. In addition, the amount of environment light may be halved due to the three state active shutter glasses opening only part of the time, thus enhancing contrast on the display.

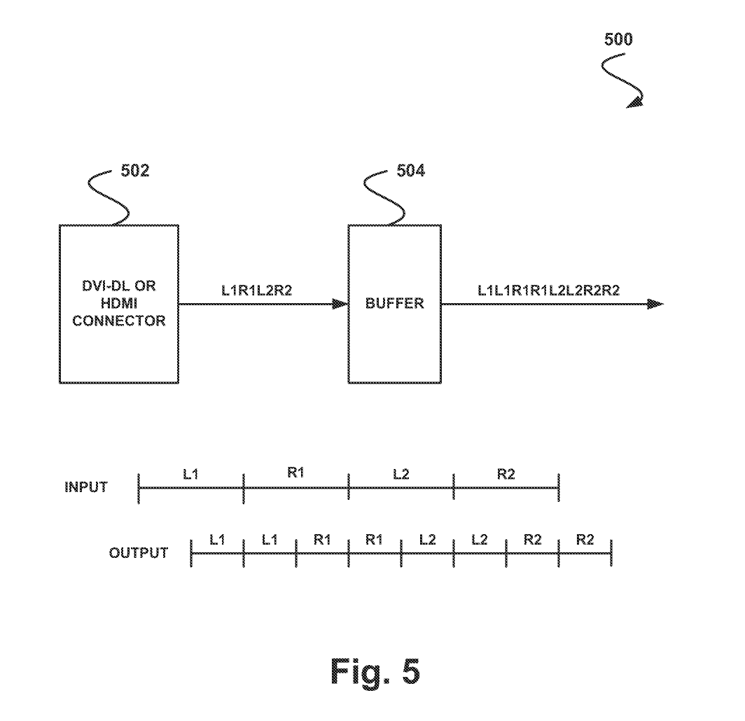

FIG. 5 illustrates a display system 500 for duplicating stereoscopic display content received at one frequency for changing the frequency at which stereo content is output, in accordance with yet another embodiment. As an option, the system 500 may be implemented in the context of the method of FIGS. 3-4. Of course, however, the system 500 may be implemented in any desired environment. Again, the definitions introduced hereinabove may apply during the following description.

As shown, stereoscopic display content [e.g. personal computer (PC) or PC or video player images] is received from an input device 502. The input device may include a DVI, DVI-dual link (DVI-DL), HMI connector, etc. In one embodiment, the stereoscopic display content is received at 120 Hertz.

Additionally, the stereoscopic display content may be received in a format which is particular from the input device 502 from which it is received. For example, in an embodiment where the input device 502 is an HDMI 1.4 input device, the stereoscopic display content may be received in a stacked frame format. As another example, in an embodiment where the input device 502 is an HDMI 1.4A input device, the stereoscopic display content may be received in a side by side format.

As shown, the stereoscopic display content is received as a sequence of frames, each frame intended for viewing by a particular eye of a user viewing the stereoscopic display content. Specifically, the frames are received in an alternating manner, whereby frames intended for viewing by a left eye of the user alternate with frames intended for viewing by a right eye of the user (i.e. L1R1L2R2, as shown). Thus, in the embodiment above where the stereoscopic display content is received at 120 Hertz, the input sequence may alternate LRLR, for 60 Hertz per eye of the user.

As also shown, a buffer 504 receives the stereoscopic display content from the input device 502. In an embodiment where the stereoscopic display content is to be output by a television, the buffer 504 may include a DRAM attached to a scalar chip of the television. In another embodiment where the stereoscopic display content is to he output by a display of a computer, the buffer 504 may include memory of the computer. The buffer 504 is then used to output a set of duplicate frames for each of the frames received from the input device 502.

As shown, the buffer 504 outputs the duplicate frames as L1, L1, R1R1, L2, L2, R2, R2, etc. By outputting the duplicate frames, the buffer 504 may output the stereoscopic display content at 240 Hertz. Thus, a display device operating at 240 Hertz may be accommodated to display the stereoscopic display content which was received at 120 Hertz.

The timing by which the buffer 504 outputs the duplicate frames upon receipt of the frames from the input device 502 may be selected in a manner such that delay through the buffer 504 is minimized. This may minimize latency associated with the output of the stereoscopic display content. In the embodiment shown, the buffer 504 begins to output the stereoscopic display content during receipt of the first frame (L1) of the stereoscopic display content. Thus, the buffer 504 may begin to output a first instance of a frame of the stereoscopic display content prior to an entirety of such frame being received from the input device 502. Just by way of example, the buffer 504 may output a line of a first instance of a frame upon receipt of such line of the frame from the input device 502. The second instance of such frame may be output without delay upon receipt of the entirety of the frame from the input device 502.

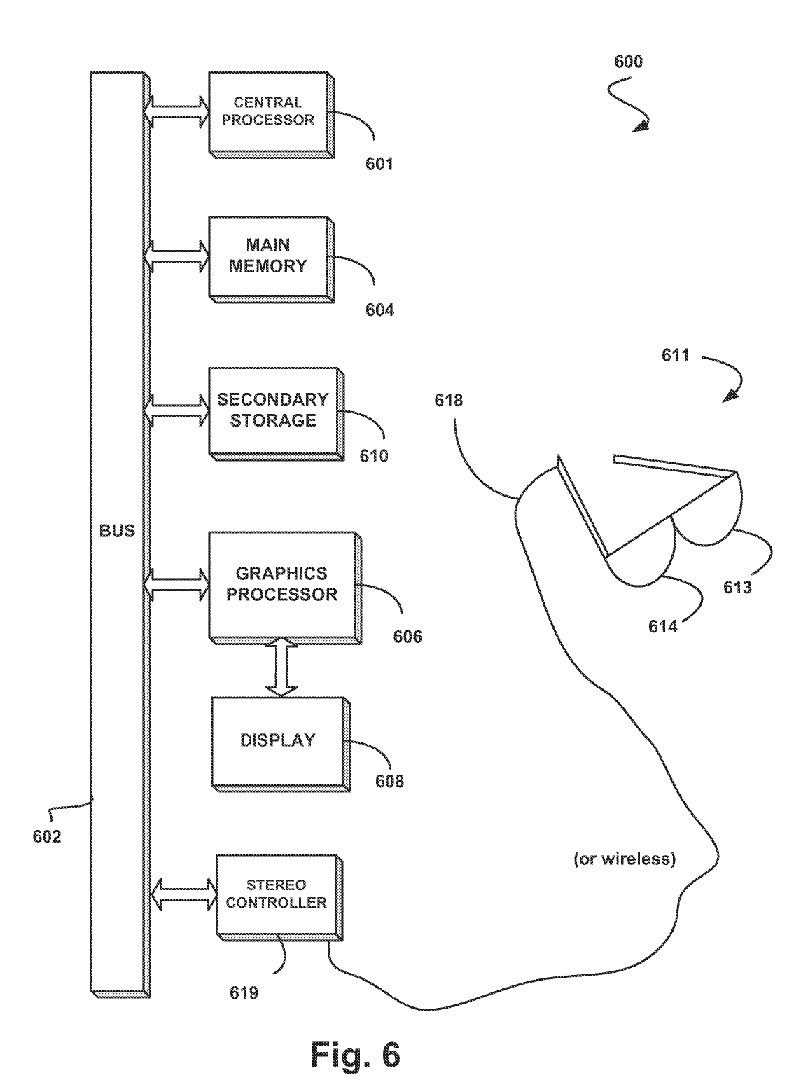

FIG. 6 illustrates an exemplary computer system 600 in which the various architecture and/or functionality of various embodiments may be implemented. As shown, a computer system 600 is provided including at least one host processor 601, which is connected to a communication bus 602. The computer system 600 also includes a main memory 604. Control logic (software) and data are stored in the main memory 604 which may take the form of random access memory (RAM).

The computer system 600 also includes a graphics processor 606 and a display 608 in the form of a liquid crystal display (LCD), digital light processing (DLP) display, liquid crystal on silicon (LCOS) display, organic light emitting diode (OLED) display, plasma display, or other similar display. In one embodiment, the graphics processor 606 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. 1t should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computer system 600 may also include a secondary storage 610. The secondary storage 610 includes, for example, a hard disk drive and/or a removable storage drive, representing a floppy disk drive, a magnetic tape drive, a compact disk drive, etc. The removable storage drive reads from and/or writes to a removable storage unit in a well known manner.

Computer programs, or computer control logic algorithms, may be stored in the main memory 604 and/or the secondary storage 610. Such computer programs, when executed, enable the computer system 600 to perform various functions. Main memory 604, secondary storage 610 and/or any other storage are possible examples of computer-readable media.

Further included is a pair of shutter glasses 611 capable of being worn on a face of a user. While the shutter glasses 611 are shown to include two elongated members for supporting the same on the face of the user, it should be noted that other constructions (e.g. member-less design, head strap, helmet, etc.) may be used to provide similar or any other type of support. As further shown, the shutter glasses 611 also include a right eye shutter 614 and a left eye shutter 613.

Both the right eye shutter 614 and left eye shutter 613 are capable of both an open orientation and a closed orientation. In use, the open orientation allows more light therethrough with respect to the closed orientation. Of course, such orientations may be achieved by any desired mechanical, electrical, optical, and/or any other mechanism capable of carrying out the above functionality.

For control purposes, the shutter glasses 611 may be coupled to a stereo controller 619 via a cable 618 (or without the cable 618 in a wireless environment). As an example, in the wireless environment, the shutter glasses 611 may he in communication with an emitter coupled to the stereo controller 619, the communication bus 602, etc. The stereo controller 619 is, in turn, coupled between the graphics processor 606 and the display 608 for carrying out the functionality described above. While the stereo controller 619 is shown to reside between the graphics processor 606 and the display 608, it should be noted that the stereo controller 619 may reside in any location associated with the computer system 600, the shutter glasses 611, and/or even in a separate module, particularly (but not necessarily) in an embodiment where the graphics processor 606 is attached to a separate interface [e.g. universal serial bus (USB), etc.] on the computer system 600. In one embodiment, the display 608 may be directly connected to the computer system 600, and the stereo controller 619 may further be directly connected to the computer system 600 via a USB interface. Still yet, the stereo controller 619 may comprise any hardware and/or software capable of the providing the desired functionality.

Specifically, in some embodiments, the right eye shutter 614 and left eye shutter 613 are controlled to switch between the closed orientation and the open orientation. As an option, the right eye shutter 614 and left eye shutter 613 of the shutter glasses 611 may be controlled such that the right eye shutter 614 and left eye shutter 613 simultaneously remain in the closed orientation for a predetermined amount of time.

In addition to and/or instead of the foregoing technique, the stereo controller 619, the display 608, and/or any other appropriate hardware/software associated with the computer system 600 may be equipped with functionality for adapting the display 608 in a way that enhances a viewing experience when display content is viewed utilizing the shutter glasses 611.

For example, in one embodiment, the architecture and/or functionality of the various following figures may be implemented in the context of the host processor 601, graphics processor 606, a chipset (i.e. a group of integrated circuits designed to work and sold as a unit for performing related functions, etc.), and/or any other integrated circuit for that matter. Still yet, the architecture and/or functionality of the various following figures may be implemented in the context of a general computer system, a circuit board system, a game console system dedicated for entertainment purposes, an application-specific system, and/or any other desired system.

For example, the system 600 may take the form of a desktop computer, lap-top computer, and/or any other type of logic. Still yet, the system 600 may take the form of various other devices including, but not limited to, a personal digital assistant (PDA) device, a mobile phone device, a television, etc.

Further, while not shown, the system 600 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. For example, any of the network elements (e.g. the graphics processors thereof) may employ any of the desired functionality set forth hereinabove. Thus, the breadth and scope of a preferred embodiment should not be limited by any of the above-described exemplary embodiments, but should be defined only in accordance with the following claims and their equivalents.

What is claimed is:

1. A method, comprising:
receiving, at a first frequency, a frame of stereoscopic display content intended for viewing by a first eye of a user; and
outputting, at a second frequency, the stereoscopic display content by:
outputting a first instance of the frame without illumination by a backlight; and
sequentially outputting one or more additional instances of the frame with illumination by the backlight.

2. The method as recited in claim 1, wherein the first frequency is 120 Hertz.

3. The method as recited in claim 1, wherein the frame is received in a stacked frame format.

4. The method as recited in claim 1, wherein the frame is received in a side-by-side format.

5. The method as recited in claim 1, further comprising buffering the frame during receipt of the frame.

6. The method as recited in claim 5, wherein the frame is duplicated to form the one or more additional instances of the frame from the buffered frame.

7. The method as recited in claim 1, wherein sequentially outputting the one or more additional instances of the frame includes outputting the one or more additional instances of the frame sequential to the output of the first instance of the frame.

8. The method as recited in claim 1, wherein sequentially outputting the one or more additional instances of the frame includes outputting a second instance of the frame sequential to a vertical blanking interval following the output of the first instance of the frame.

9. The method as recited in claim 1, wherein a plurality of frames are received at the first frequency including a first frame of first display content intended for viewing by the first eye of the user and a second frame of second display content intended for viewing by a second eye of the user, and the outputting, at the second frequency, the stereoscopic display content includes:
outputting in sequence a first instance of the first frame and at least one additional instance of the first frame; and
after the sequential output of the first instance of the first frame and the at least one additional instance of the first frame, outputting in sequence a first instance of the second frame and a at least one additional instance of the second frame.

10. The method as recited in claim 1, wherein the second frequency includes 240 Hertz.

11. The method as recited in claim 1, wherein the second frequency is faster than the first frequency.

12. The method as recited in claim 1, wherein the frame is received and output by a processor of a television utilized for the outputting of the stereoscopic display content.

13. The method as recited in claim 1, wherein the frame is received by a processor of a computer connected to a display utilized for the outputting of the stereoscopic display content.

14. The method as recited in claim 1, wherein the backlight is activated in response to the outputting of the one or more additional instances of the frame.

15. The method as recited in claim 14, wherein the backlight is activated a predetermined amount of time after initiation of the outputting of the one or more additional instances of the frame.

16. The method as recited in claim 1, wherein the backlight is deactivated during the outputting of the first instance of the frame.

17. The method as recited in claim 1, further comprising:
during the outputting of the first instance of the frame, instructing active shutter glasses utilized by the user to view the stereoscopic display content to close a lens worn over the first eve of the user and to close a lens worn over a second eye of the user; and
during the outputting of the one or more additional instances of the frame, instructing the active shutter glasses to open the lens worn over the first eye of the user and to close the lens worn over the second eye of the user.

18. A computer program product embodied on a tangible computer readable medium, comprising:
computer code for receiving, at a first frequency, a frame of stereoscopic display content intended for viewing by a first eye of a user; and
computer code for outputting, at a second frequency, the stereoscopic display content by:
outputting a first instance of the frame without illumination by a backlight; and
sequentially outputting one or more additional instances of the frame with illumination by the backlight.

19. A system, comprising:
a processor for:
receiving, at a first frequency, a frame of stereoscopic display content intended for viewing by a first eye of a user; and
outputting, at a second frequency, the stereoscopic display content by:
outputting a first instance of the frame without illumination by a backlight; and
sequentially outputting one or more additional instances of the frame with illumination by the backlight.

20. The system as recited in claim 19, wherein the processor is coupled to memory via a bus.
